(19) United States
(12) Patent Application Publication
(10) Pub. No.: US 2009/0122776 A1
(43) Pub. Date: May 14, 2009

(54) SYSTEM AND METHOD OF VERIFICATION OF HSDPA LAYER 1 CODING IN A NODE

(76) Inventors: Bjorn Folkstedt, Molndal (SE); Jan Lindskog, Pixbo (SE)

Correspondence Address: ERICSSON INC., 6300 LEGACY DRIVE, M/S EVR 1-C-11, PLANO, TX, 75024, US

(21) Appl. No.: 11/937,942

(22) Filed: Nov. 9, 2007

(51) Int. Cl. H04B 7/216

(52) U.S. Cl. 370/342

(57) ABSTRACT

A system and method of verifying layer 1 coding in a node. The method begins by conducting downlink processing of user data by a node. The node then outputs coded data. Next, downlink processing of the user data is conducted by an independent reference model. The independent reference model utilizes scheduler decisions from the node to conduct the downlink processing. The reference model then outputs coded data. The coded data from the node is compared with the coded data from the reference model. If the coded data from the node is substantially similar to the coded data from the reference mode, the coded data from the node is correct.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### TECHNICAL FIELD

This invention relates to communication systems. More particularly, and not by way of limitation, the invention is directed to a system and method of verifying High Speed Data Packet Access (HSDPA) layer 1 coding in a node.

### BACKGROUND

Currently, there is a rapid expansion of multimedia wireless networks due to an increase in demand for Internet-like services, such as web browsing, dynamic sharing of resources and streaming audio and video. These wireless networks can either be mobile or fixed. Mobile networks are known as third generation (3G) mobile communication systems. Unlike previous types of mobile networks that carried mainly circuit switched voice traffic from PSTN (Public Switched Telephone networks), 3G networks can carry various packet data from a variety of networks, including PSTN, B-ISDN, PLMN and Internet.

There is an ongoing process of standardizing a set of protocols collectively known as the Universal Mobile Telecommunications Systems (UMTS). FIG. 1 illustrates a simplified block diagram of a UMTS network 200 that comprises a 3G network referred to as a core network 202 and a UMTS Terrestrial Radio Access Network (UTRAN) 204. The UTRAN comprises a plurality of Radio Networks Controllers (RNCs) 206. There are various RNCs performing various roles. Each RNC is connected to a set of base stations. A base station is often called Node-B. Each Node-B 208 is responsible for communication with a User Equipment (UE) 210 within a given geographical cell. The serving RNC is responsible for routing user and signalling data between a Node-B and the core network. The interface between the core network and the RNCs is referred to as Iᵤ, while the interface between the RNCs is labelled Iᵤᵣ. The interface between the RNCs and the Node-Bs is denoted I_{ub} and the air interface between the Node-Bs and the mobile terminals is the Uᵤ interface.

HSDPA is a feature which has been added to the functionality in 3^{rd} Generation Partnership Project (3GPP) to support higher data downlink rates. To facilitate these higher data downlink rates, a new channel called High Speed Downlink Shared Channel (HS-DSCH) has been added. HS-DSCH is a channel that is shared among all the HSDPA users in a cell. Unlike other channels, HS-DSCH requires a scheduler to determine which users the Node-B should transmit data for each time transmission interval (TTI). In addition, the scheduler also decides the rate of these transmissions.

The behavior of the scheduler is not described in the 3GPP standard. Scheduling in this scheme does not require standardization. In addition, scheduling is dependent on the type of service that an operator offers its customers, which may vary from operator to operator. The other parts of the HSDPA, such as the rest of the Layer 2 (L2) processing and Layer 1 (L1) coding (according to the Open System Interconnection (OSI)) is described in detail in 3GPP.

In existing systems, the scheduler may base its decisions on the current radio conditions on the air, traffic priorities, current amount of data in the queues for the different users, remaining power, user equipment (UE) capabilities, priorities between the users, how long the data has been stored in the queues, errors when sending previous data, etc. To assist the scheduler with some of this information, 3GPP states that the UEs must report their experienced radio conditions with channel quality indicators (CQIs) to a Node-B. For each data package that a UE receives, a Hybrid Automatic Repeat Request Acknowledgement/No Acknowledgement (HARQ ACK/NACK) report is also provided if it was able to successfully decode the data or not.

FIG. 2 is an HSDPA perspective of a Node-B 10 in an existing system. User data 12 is provided to the Node-B over an I_{UB} interface 14. The user data is sent to input buffers 16 of the Node-B. The Node-B includes a downlink (DL) processing functionality 18. The DL processing functionality may include an HSDPA DL processing functionality 20, an Enhanced Uplink (EUL) DL processing functionality 22, and a Common Channel/Dedicated Channel (CCH/DCH) DL functionality 24. The EUL DL processing functionality provides the HSDPA DL processing functionality with the amount of power it has consumed. Likewise, the CCH/DCH DL processing provides the HSDPA DL processing functionality with the amount of power it has consumed. This is done so that the HSDPA DL processing functionality may check the remaining power that it can use for transmission of HSDPA. An Uplink (UL) processing functionality 26 provides CQI and HARQ ACK/NACK messages to the HSDPA DL processing functionality. The Node-B also includes a radio interface 28 communicating with a UE 30 via High Speed Physical Downlink Shared Channel (HS-PDSCH) and HS-DSCH Shared Control Channel (HS-SCCH). The UE also provides CQI and HARQ ACK/NACK messages to the Node-B via the HS-DPCCH. A scheduler 50 is located within the HSDPA DL processing functionality.

Based on the inputs provided to a scheduler from the Node-B 10, the scheduler 50 chooses one or several UEs to send data to. The data is L1 coded according to 3GPP (See 3GPP 25.212 and 3GPP 25.213). FIG. 3 illustrates an HSDPA downlink processing block 52 extracted from FIG. 2. The HSDPA downlink processing receives user data 54 and L2 inputs (CQI, etc.) 56. The L2 processing includes utilizing the scheduler 50. L1 coding is performed and coded data 58 is outputted.

It is critical that L1 coding is exactly correct. If the L1 coding is not correct, the UE will not be able to decode the data or lead to a significantly lower data rate. There are several existing ways to verify that the L1 coding is correct. One way to verify that the L1 coding is correct is to attempt to decode the coded output data. If the data is decodable, it is an indication that the data is coded correctly. However, it is not enough to make sure that the data is coded correctly since it is not known what the L2 processing (i.e. the layer 2 parts of the Medium Access Control high speed (MAC-hs) protocol) actually ordered the L1 coding to do. For example, the scheduler decision could have caused the L1 coding to code a channel with a certain power. An error in the L1 coding may cause the L1 coding to use the wrong channel power. This would not be discovered when the data is decoded because it is possible to decode the channel anyway. Even when the power is explicitly checked, it would still not be possible to decide whether it is correct because it is not known what power the scheduler ordered the L1 coder to use. In addition, if an error is discovered, it is difficult to determine what the error is since it is only known that decoding of the data is not possible. However, it would not be known what the data should be in order to decode it.

In another way, it may be possible to predict the coded data. However, it would be difficult since it is necessary to predict both the behavior of the L1 coding and the scheduler. The scheduler may be complex and it would be an enormous task to forecast its decisions. In addition, the nature of the scheduler typically makes it very hard to predict its decisions. The scheduler is dependent on information, such as CQI and user data, that is received by the scheduler. In order to predict the scheduler's decisions, it would be necessary to know exactly when this information is taken into consideration by the scheduler. Depending on internal delays in the scheduler implementation and in its environment, this could be difficult or impossible to know.

A third way to verify that the L1 coding is correct is to use reference mobile phones from another vendor to see if the data is decodable by that UE. However, this method requires the implementation of another network in order to work. Such a network is typically available late in the development process (i.e., it is not suitable for verification of the L1 coding). The faults would be hard to locate in such a large system and the cost to correct them would be high at a late stage, especially when the L1 coding typically is implemented in a non-reprogrammable hardware.

Thus, it would be advantageous to have a system and method of verifying L1 coding in an effective and timely manner. The present invention provides such a system and method.

### SUMMARY

In one aspect, the present invention is directed to a method of verifying layer 1 coding in a node. The method begins by conducting downlink processing of user data by a node. The node then outputs coded data. Next, downlink processing of the user data is conducted by an independent reference model. The independent reference model utilizes scheduler decisions from the node to conduct the downlink processing. The reference model then outputs coded data. The coded data from the node is compared with the coded data from the reference model. If the coded data from the node is substantially similar to the coded data from the reference model, the coded data from the node is correct.

In another aspect, the present invention is a node within a telecommunications network. The node conducts downlink processing of user data. The node then outputs coded data resulting from the downlink processing of the user data. A reference model within the node then utilizes scheduler decisions from the node to conduct the downlink processing. The reference model then outputs coded data from the reference model. The node compares the coded data from the node with the coded data from the reference model. The coded data from the node is verified as correct if the coded data from the node is substantially similar to the coded data from the reference model.

In another aspect, the present invention is a telecommunications system for verifying layer 1 coding in a node. The system includes a node conducting downlink processing of user data. The node outputs coded data resulting from the downlink processing of the user data. In addition, the system includes an independent reference model conducting independent downlink processing of the user data. The reference model utilizes scheduler decisions from the node to conduct the downlink processing and outputs coded data resulting from the downlink processing. The coded data from the node is then compared with the coded data from the reference model. The coded data from the node is correct if the coded data from the node is substantially similar to the coded data from the reference model.

The present inventions advantageously provides a simple system and methodology for verifying HSDPA layer 1 coding in a node without requiring the prediction of scheduler decisions. The present invention utilizes a reference model to compare L1 coding output to determine errors in coding, thereby providing an easily implemented system and method to existing telecommunication networks.

### BRIEF DESCRIPTION OF THE DRAWING

In the following, the features of the invention will be described in detail by showing preferred embodiments, with reference to the attached figures in which:

FIG. 1 (prior art) illustrates a simplified block diagram of a UMTS network;

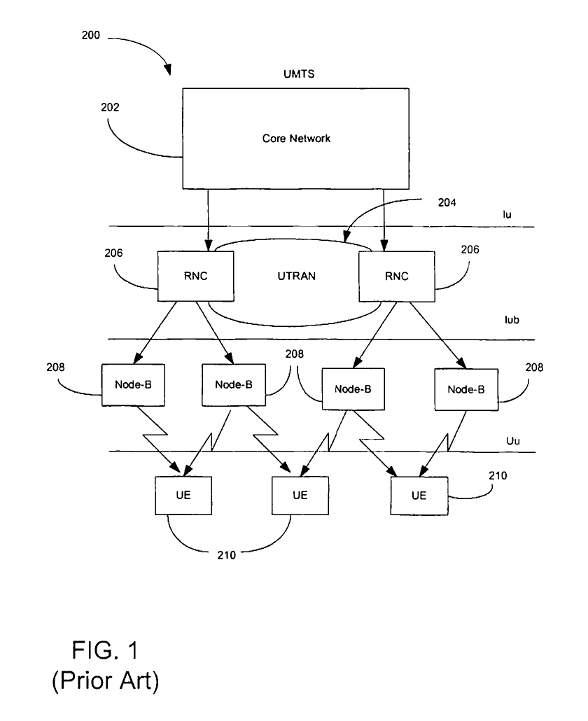

FIG. 2 (prior art) is an HSDPA perspective of a Node-B in an existing system;

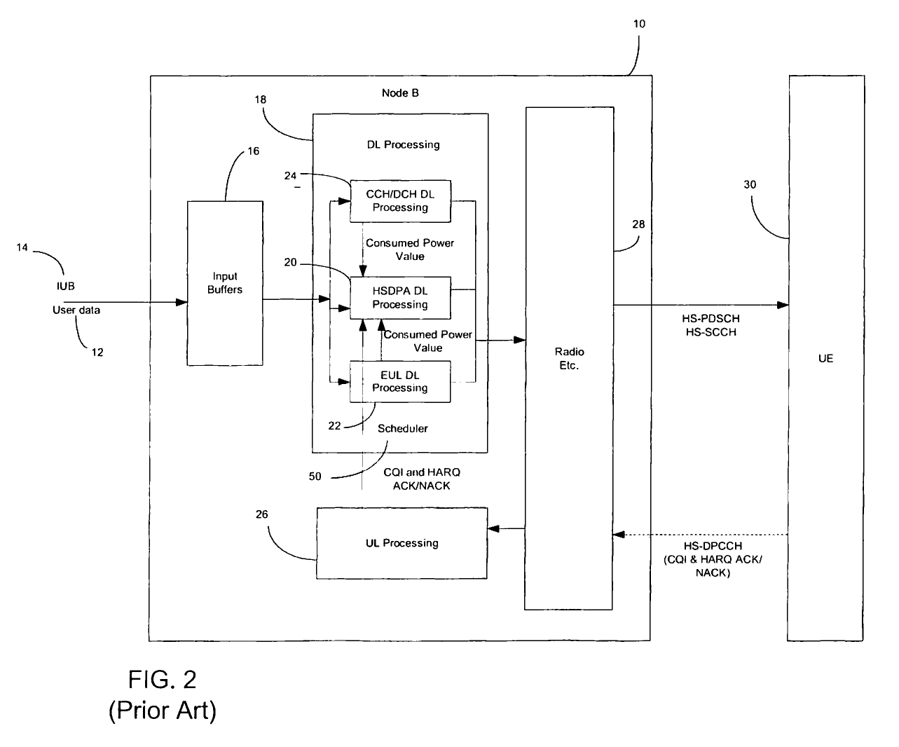

FIG. 3 (prior art) illustrates an HSDPA downlink processing block extracted from FIG. 2;

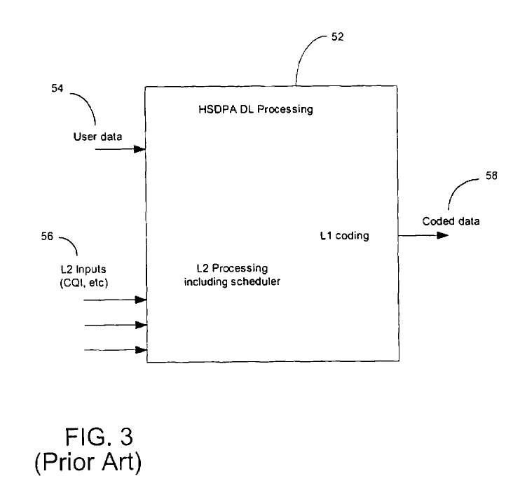

FIG. 4 is a simplified block diagram of a verifying system residing within the Node-B;

FIG. 5 is a simplified block diagram of the verification process of the verifying system in the preferred embodiment of the present invention; and

FIG. 6 is a flow chart illustrating the steps of verifying the L1 coding in the HSDPA DL processing according to the teachings of the present invention.

### DETAILED DESCRIPTION

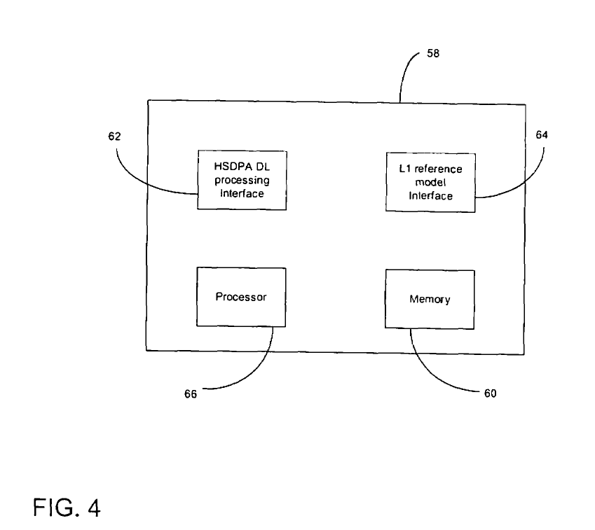

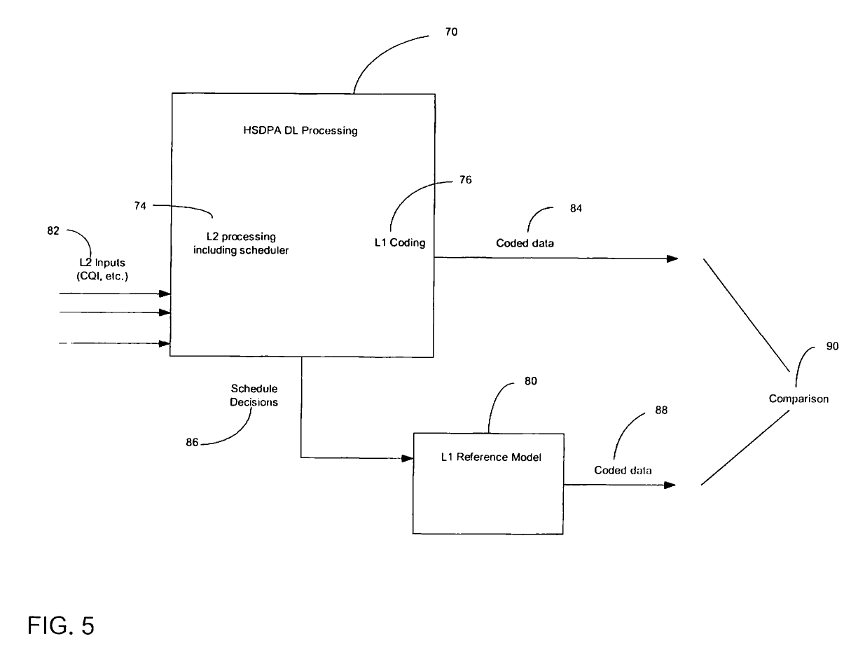

The present invention is a system and method of verifying HSDPA layer 1 coding in a node. FIG. 4 is a simplified block diagram of a verifying system 58 residing within the Node-B 10. The verifying system includes a memory 60, an interface 62 with the HSDPA DL processing functionality 18, an interface 64 with a L1 reference model 80 (see FIG. 5), and a processor 66. In the present invention, scheduler and L2 processing decisions (known as scheduler decisions) are extracted from the downlink processing. The scheduler decisions are utilized as an input to an independent implementation, the L1 reference model 80. The output data from the downlink processing and the output from the reference model are compared by the processor 66. It will be appreciated by those skilled in the art that the scheduler decision includes scheduler information sent through the service access point (SAP) that interconnects the layer 2 functionality and the layer 1 functionality in the Node-B. Referring to the OSI layer, the SAP is a conceptual location at which one OSI layer may request the service of another OSI layer. such as HS-SCCH channelization-code set, modulation scheme, transport block size and Hybrid-ARQ related information such as Hybrid-ARQ process number, redundancy version, and new-data indication as well as the power for the HS-SCCH channel.

The scheduler information includes HS-SCCH control information, e.g., Transport-Format and Resource-related information (TFRI) such as HS-DSCH channelization-code set, modulation scheme, transport block size and Hybrid-ARQ related information such as Hybrid-ARQ process number, redundancy version, new-data indication as well as the power of the HS-SCCH channel. The scheduler information also includes the MAC-hs header with reordering queue identity, transmission sequence number and the number and size of the MAC-d PDUs as well as the actual MAC-hs payload and the power for the HS-PDSCH channel. In addition, the scheduling information includes a static part which is not changed from transmission time to transmission time, e.g., the UE ID (i.e., the Radio Network Temporary Identifier (RNTI)), the cell timing information, the scrambling code for the cell, the soft buffer size of the UE and the HS-SCCH code. The scheduler information does not have to be implemented from a single interface from a Node-B, but instead may be derived from multiple interfaces or data repositories. In particular, the static part does not have to be sent for each transmission time.

FIG. 5 is a simplified block diagram of the verification process of the verifying system 58 in the preferred embodiment of the present invention. HSDPA DL processing occurs within block 70 having the scheduler 50. The HSDPA DL processing includes L2 processing 74 and L1 coding 76. User data is provided for HSDPA DL processing. In addition, L2 inputs (CQI, etc.) 82 are provided for HSDPA DL processing. Coded data 84 is output from the HSDPA DL processing block 70. The HSDPA DL processing provides scheduler decisions 86 to the L1 reference model 80. In addition, user data is sent to the L1 reference model 80 via scheduling data. Thus, the scheduler decisions serve as an input to an independent implementation, specifically, the L1 reference model 80. The L1 reference model then outputs coded data 88. The coded data 84 from the HSDPA DL processing is provided through the interface 62 to the memory 60. The coded data 88 from the L1 reference model is sent to the memory via the interface 64. The coded data 88 is compared with the coded data 84 by the processor at 90. If the outputs are substantially similar, then the L1 coding in the HSDPA DL processing is considered correct.

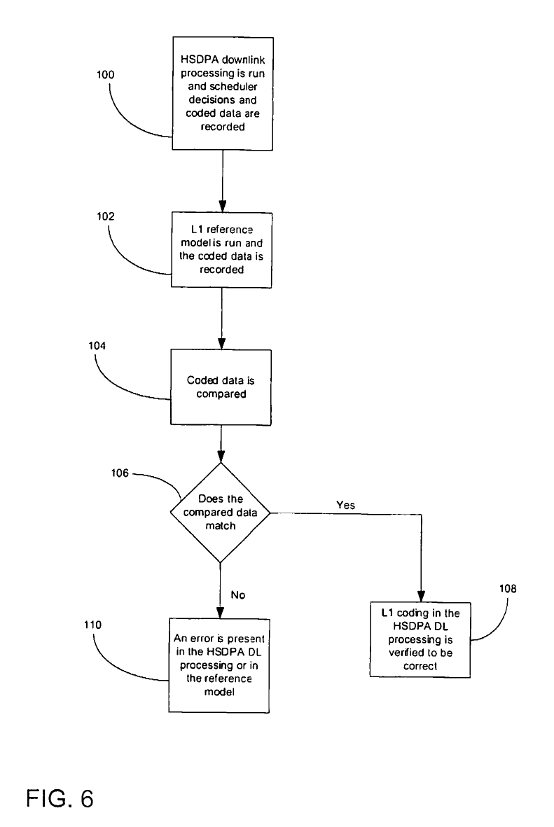

FIG. 6 is a flow chart illustrating the steps of verifying the L1 coding in the HSDPA DL processing according to the teachings of the present invention. With references to FIGS. 5 and 6, the method will now be explained. The method begins with step 100 wherein the HSDPA downlink processing is run. The scheduler decisions 86 for each TTI is also extracted and recorded to the memory 60. In addition, the output from the L1 coding, the coded data 84, is recorded. It is unimportant what types of scheduler algorithms are utilized to test the L1 coding parts. In addition, it is not necessary to have a correct L2 processing behavior in every aspect since the resulting scheduler decisions are usable anyway. Next, in step 102, the scheduler decisions 86 are provided to the L1 reference model 80. The L1 reference model is an implementation of the L1 coding according to 3GPP (see 3GPP 25.212 and 3GPP 25.213) that is independent of the implementation done in the downlink processing in 70. The output, i.e. the coded data 88 from the L1 reference model 80 is also recorded. In step 104, the output from the L1 reference model is compared with the output from the HSDPA downlink processing (i.e., coded data 88 versus coded data 84). The comparison is made chip by chip to determine if the outputs (coded data 84 and coded data 88) are substantially similar (i.e., each chip from the HSDPA downlink processing is compared with each chip form the L1 reference model). Next, in step 106, it is determined if the coded data 84 is substantially similar to the coded data 88 from the L1 reference model. If the coded data is substantially similar, the next step in the method is step 108 where the L1 coding in the HSDPA DL processing is verified to be correct. However, in step 106, if it is determined that the data is not substantially similar, the next step is step 110 where it is determined that there is an error in the HSDPA DL processing (or possibly the reference model).

It should be understood by those skilled in the art that the present invention, although described for HSDPA may be implemented in other networking schemes, such as Enhanced Uplink, Wideband Code Division Multiple Access (WCDMA) Evolved, and Long Term Evolution (LTE). The present invention provides an efficient and accurate way of verifying Layer 1 coding. In addition, the present invention provides for a prediction of the L1 coding which may be easily obtained from a reference model of the L1 coding. Furthermore, the present invention can determine any error in the L1 coding. Once an error is discover, it is a simple process to determine what is wrong with the L1 coding. Once an error is found in the L1 coding in the HSDPA downlink processing, the reference model output reveals the correct answer. The present invention is independent of the scheduler. Additionally, there is no need to predict the scheduler decisions.

In an alternate embodiment of the present invention, the scheduler decision may not entirely reflect information sent in the layer 2 to layer 1 SAP as discussed above, but rather include a subset of the layer 2 to layer 1 SAP information plus additional information. This additional information may be information from the layer 2 or the layer 1 functionality. For example, in the case where a Node B has a Cyclic Redundancy Check (CRC) of the HS-SCCH which is a layer 1 functionality co-located with the layer 2 functionality. The CRC for the HS-SCCH utilizes a channelization-code set, modulation scheme, transport-block size, Hybrid ARQ parameters and UE ID (i.e. RNTI) which are all elements of the layer 2 to layer 1 SAP. In this embodiment, it is possible to exclude some information from the scheduling information (e.g., UE ID parameter) and instead include the resulting CRC checksum as a member of the scheduling information.

Although preferred embodiments of the present invention have been illustrated in the accompanying drawings and described in the foregoing Detailed Description, it is understood that the invention is not limited to the embodiments disclosed, but is capable of numerous rearrangements, modifications, and substitutions without departing from the scope of the invention. The specification contemplates all modifications that fall within the scope of the invention defined by the following claims.

1. A method of verifying layer 1 coding in a node, the method comprising the steps of:
conducting downlink processing of user data by a node;
outputting coded data from the node;
conducting downlink processing of user data by a reference model, the reference model utilizing scheduler decisions from the node to conduct the downlink processing;
outputting coded data from the reference model; and
comparing the coded data from the node with the coded data from the reference model;
wherein the coded data from the node is correct if the coded data from the node is substantially similar to the coded data from the reference mode.

2. The method of verifying layer 1 coding in a node of claim 1 wherein the node is a node-B operating in a network.

3. The method of verifying layer 1 coding in a node of claim 1 wherein the step of downlink processing of user data by a node includes conducting High Speed Data Packet Access (HSDPA) downlink processing of the user data.

4. The method of verifying layer 1 coding in a node of claim 1 wherein the scheduler decisions includes information sent through a service access point that interconnects a layer 2 functionality and a layer 1 functionality during the downlink processing in the node.

5. The method of verifying layer 1 coding of claim 4 in a node wherein the scheduler information includes additional information from the layer 2 or the layer 1 functionality.

6. The method of verifying layer 1 coding in a node of claim 1 wherein the reference model is an independent implementation from the node of the downlink processing of the user data.

7. The method of verifying layer 1 coding in a node of claim 1 wherein the coded data of the node contains an error if the coded data of the node is not substantially similar to the coded data of the reference model.

8. The method of verifying layer 1 coding of claim 1 in a node wherein the step of conducting downlink processing includes conducting Enhanced Uplink downlink processing.

9. The method of verifying layer 1 coding of claim 1 in a node wherein the step of conducting downlink processing includes conducting Long Term Evolution (LTE) downlink processing.

10. The method of verifying layer 1 coding of claim 1 in a node wherein the step of conducting downlink processing includes conducting Wideband Code Division Multiple Access (WCDMA) Evolved downlink processing.

11. A node within in a telecommunications network, the node comprising:
means for conducting downlink processing of user data by a node, wherein the node outputs coded data resulting from the downlink processing of the user data;
means for conducting downlink processing of the user data by a reference model, the reference model utilizing scheduler decisions from the node to conduct the downlink processing and outputting coded data from the reference model; and
means for comparing the coded data from the node with the coded data from the reference model;
wherein the coded data from the node is correct if the coded data from the node is substantially similar to the coded data from the reference model.

12. The node within in a telecommunications network of claim 11 wherein the node is a node-B operating in a network.

13. The node within in a telecommunications network of claim 11 wherein the means for conducting downlink processing of user data by a node includes conducting High Speed Data Packet Access (HSDPA) downlink processing of the user data.

14. The node within in a telecommunications network of claim 11 wherein the scheduler decisions includes information sent through a service access point that interconnects a layer 2 functionality and a layer 1 functionality made during the downlink processing in the node.

15. The node within in a telecommunications network of claim 14 wherein the scheduler information includes additional information from the layer 2 or the layer 1 functionality.

16. The node within in a telecommunications network of claim 11 wherein the reference model is an independent implementation from the node of the downlink processing of the user data.

17. The node within in a telecommunications network of claim 11 wherein the coded data of the node contains an error if the coded data of the node is not substantially similar to the coded data of the reference model.

18. A telecommunications system for verifying layer 1 coding in a node, the system comprising:
a node conducting downlink processing of user data, the node outputting coded data resulting from the downlink processing of the user data;
a reference model conducting independent downlink processing of the user data, the reference model utilizing scheduler decisions from the node to conduct the downlink processing and outputting coded data resulting from the downlink processing; and
means for comparing the coded data from the node with the coded data from the reference model;
wherein the coded data from the node is correct if the coded data from the node is substantially similar to the coded data from the reference model.

19. The telecommunications system for verifying layer 1 coding in a node of claim 18 wherein the node is a node-B operating in a network.

20. The telecommunications system for verifying layer 1 coding in a node of claim 18 wherein the node conducts High Speed Data Packet Access (HSDPA) downlink processing of the user data.

21. The telecommunications system for verifying layer 1 coding in a node of claim 18 wherein the scheduler decisions includes information sent through a service access point that interconnects a layer 2 functionality and a layer 1 functionality made during the downlink processing in the node.

22. The telecommunications system for verifying layer 1 coding in a node of claim 21 wherein the scheduler information includes additional information from the layer 2 or the layer 1 functionality.

23. The telecommunications system for verifying layer 1 coding in a node of claim 18 wherein the reference model is an independent implementation from the node of the downlink processing of the user data.
